(19) United States
(12) Patent Application Publication
(10) Pub. No.: US 2006/0151227 A1
(43) Pub. Date: Jul. 13, 2006

(54) Automobile with vehicle seats equipped with pressure sensors

(76) Inventor: Ulrich Reith, Schlier (DE)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 11/325,755

(22) Filed: Jan. 5, 2006

(30) Foreign Application Priority Data
Jan. 13, 2005 (DE) 10 2005 001 508.5

(51) Int. Cl. B60K 28/04

(52) U.S. Cl. 180/273

(57) ABSTRACT

An automobile with one or several vehicle seats equipped with pressure sensors to obtain the weight of a respective vehicle seat occupied by a person and by way of a control unit to evaluate the pressure sensor signals as well as to control the given functional units of the vehicle which are dependant upon the pressure sensor signals. The control unit in a vehicle that has an automated transmission can operate to make sure that the transmission of the standing vehicle can not be switched on and that with a running engine and an unoccupied driver's seat the transmission is automatically switched to “NEUTRAL” or the parking brake is engaged. Likewise, the control unit can be used to operate comfort functions for the respective seats.

This application claims priority from German Application Serial No. 10 2005 001 508.5 filed Jan. 13, 2005.

### FIELD OF THE INVENTION

This invention concerns an automobile with vehicle seats equipped with pressure sensors.

### BACKGROUND OF THE INVENTION

It is already known that it is important to equip the vehicle seats of automobiles with pressure sensors while the weight of the person is in the seat in order to obtain the functional parameters for the airbag devices. Thus the effect of the airbag systems assigned to the respective vehicle seats can also be tuned to facilitate the protection of the passenger. This is important to avoid an either too strong or too weak deployment of the airbags.

From the EP 0 866 755 B1 an airbag system with a variable deployment time is already known in which the weight and the seat position of the vehicle seats occupied by vehicle passengers are determined and then the ascertained values—in addition to other parameters which are entered into the control unit—are used to determine the time and length of the airbag deployment.

The construction and technical production expenses for the installation of pressure sensors in vehicle seats is prohibitively large, in particular when one considers that the airbag system of automobiles just sits there and in the most favorable case is never used during the entire lifetime of the automobile. In these most common cases the installation of pressure sensors in vehicle seats is a substantial additional cost factor without any expectation of their being used under normal conditions.

With this background the following task forms the basis of the invention for an automobile to improve the effectiveness of pressure sensors installed in one or more vehicle seats.

### SUMMARY OF THE INVENTION

The invention is based on the realization that knowledge forms the basis of the invention such as whether or not the driver's seat or other vehicle seats are occupied or unoccupied and other important and useful criteria for the control of safety-relevant and travel-comfort functional units so that with the help of the pressure sensors both the safety and the travel comfort of the automobile can be improved as well as the effectiveness of the installation of the pressure sensors at an overall affordable cost.

Therefore the invention goes from the automobile to the pressure sensors installed in one or more vehicle seats, obtains the weight of each person located in each respective vehicle seat and uses the control unit to evaluate the pressure sensor signals and control the functional units of the automobile.

For the solution of the task at hand, different export examples are planned which concern the safety-relevant and travel-comfort features of the units with the safety-relevant functions being foremost. A particular safety problem occurs in automobiles with automated transmissions, which is explained below.

Therefore, the first design of the invention is for a vehicle with an automated transmission under the following operating conditions:

The automobile is stopped;

The engine is running;

The key is in the ignition, and

The driver seat does not have any weight on it.

It automatically places the transmission in “NEUTRAL” (N) and/or activates the “PARKING” (P) brake.

With automatic transmissions, as well as with automated transmissions, the danger exists that the driver will leave the vehicle with the engine running and the key in the ignition. This is conceivable, in particular, if the automated operation of the vehicle clutch is coordinated so that the vehicle remains standing after the brakes are released and doesn't creep forward as generally occurs with automatic gears. The malfunctioning of the ignition (e.g., for the engine or transmission), the accelerator (e.g., accelerator pedal) or the failure of a component (e.g., gearshift, control valve) can cause the inadvertent movement of the vehicle in this situation. Because the driver cannot intervene, the negative consequences in these cases must be considered.

Inadvertent starting or rolling of the vehicle can be avoided by a control unit with the design described above because if the driver leaves his seat the transmission will automatically switch to NEUTRAL or the park brake will become engaged.

Indeed, a procedure already exists by DE 102 58 834A whereby control of the automated transmission is dependent of whether or not the driver's door is open or closed. Nevertheless, this procedure is not suitable in this case where the driver has gotten out of the vehicle and the vehicle has started to move inadvertently, because the driver might have closed the door after he got out or it might have closed by itself, so the only control then is when the driver remains behind the wheel.

In accordance with another design of the invention, which is intended to increase safety measures, the control unit for the locks of one or all the doors is placed so that it cannot be accidentally struck when the aforementioned operating conditions occur. It is, therefore, not possible that the driver could be locked out by a malfunctioning of the lock control unit or also by the use of a second key.

In addition, according to another design of the invention, the control unit can be laid out according to the following operating conditions:

The motor is running, and

The driver's seat is occupied.

To activate a mechanism for the automatic positioning of the driver's seat depending on the measured driver's weight in a given position. In addition, information on the weight and different seat positions for each driver can be stored in the memory of the mechanism and then when one of these drivers takes the driver's seat it can automatically be adjusted for that driver.

The present invention also offers the possibility to activate or shut off functions assigned to the individual seats as is stated in the following. Therefore, according to another design of the invention, the control unit is laid out for an individual vehicle seat equipped with pressure sensors under the following operating conditions:

The motor is running, and

The driver's seat is not occupied.

To shut off the power to a single or all electrically equipped respective vehicle seats. This offers the possibility, therefore, to shut off heated seats and massage seats, which are not occupied so that they aren't inadvertently switched on.

There is yet another invention design to cover the following operating conditions:

The motor is running, and

The driver's seat is occupied.

To activate a single or all electric functions for a respective vehicle seat, for instance, for the automatic fastening of the seat belt, see the warning “fastening seat belts”, the automatic activation of the seat heating or climate control, setting the seat springs based on calibration of the occupant's weight.

According to another design of the invention the control unit is laid out in addition as follows, on all vehicle seats equipped with pressure sensors under the following applicable operating conditions:

The motor is running, and

All the vehicle seats are not occupied.

To switch off the electrical functions like heating, air-conditioning, the radio or such to one or all of the vehicle seats.

In addition, the invention also offers the possibility to determine the acceleration speed of the vehicle by the seat load of the respective passengers and in the case of dangerous driving involving the steering system, to apply suitable countermeasures by changing gears and applying the brakes.

For this purpose it is planned, in accordance with the invention design, that several pressure sensors be arranged at least at seat level for each seat (and if necessary above the back of the seat) in order for the control unit to evaluate individually the pressure sensors and the pressure distributed over them to obtain the respective level and to determine a pressure distribution during acceleration of the vehicle, as well as to control the steering system and/or the gearshift and/or the brake assembly in order to optimize the driving conditions as a function of the ascertained acceleration state.

### BRIEF DESCRIPTION OF THE DRAWINGS

The invention will now be described, by way of example, with reference to the accompanying drawings in which:

FIG. 1 and FIG. 2 in each case a flowchart referring to the driver's seat, and

FIG. 3 and FIG. 4 in each case a flowchart referring to the vehicle seats in general.

### DETAILED DESCRIPTION OF THE INVENTION

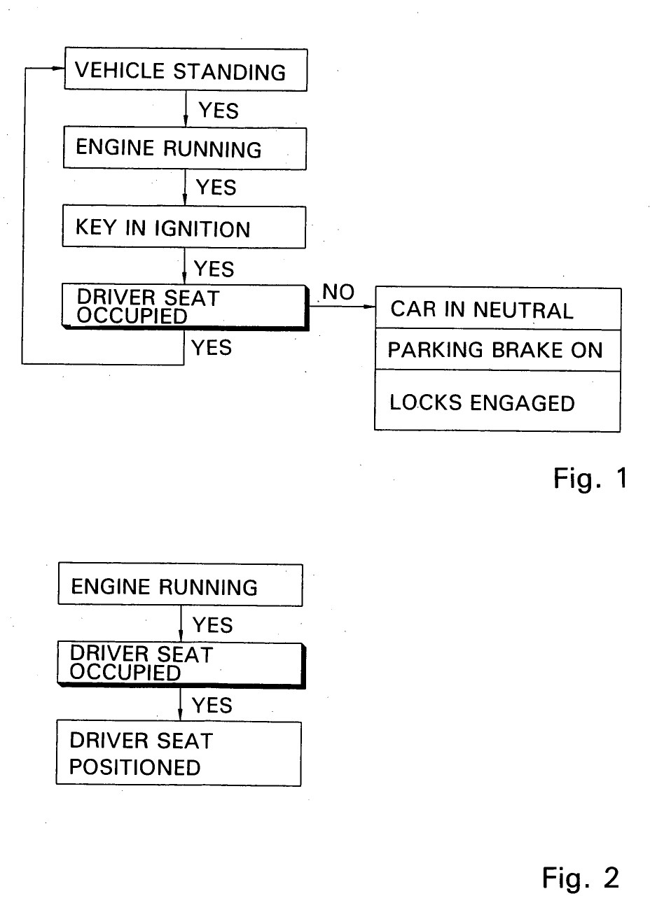

FIG. 1 shows how the control unit checks the vehicle with an automated transmission in cases where the vehicle is stopped, the engine is running and the key is in the ignition whether the driver's seat is occupied or not. If the driver's seat is not occupied, the control unit switches the transmission to “NEUTRAL” and/or additionally alerts the door lock unit to prevent one or all of the doors from being locked.

In addition to determining whether or not the driver's seat is occupied, the control unit can determine by weight whether or not the person in the driver's seat is an adult or not. In this way, the described unit is very safety-relevant as it can determine if the person sitting in the driver's seat is of a lower weight like that of a child.

As FIG. 2 shows, the control unit can determine if the engine is running, whether the driver's seat is occupied or not. When the driver's seat is occupied, it can automatically place the seat in the assigned position stored in its memory based on the driver's weight.

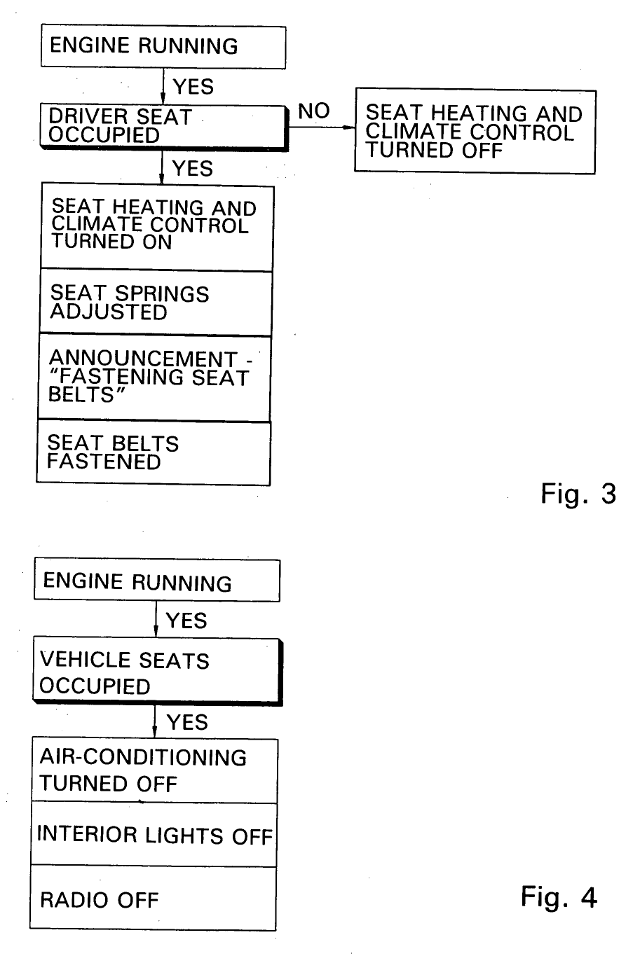

In accordance with FIG. 3 and as the flowchart shows, the control unit checks every vehicle seat to determine whether or not it's occupied when the engine is running. If a vehicle seat is occupied, for instance, the seat heating and climate control for this seat are switched on, the seat springs are adjusted based on the passenger's weight, the automatic “fasten seat belt” option is activated and/or the seat belt assigned to the seat is ignored if the vehicle seat is not occupied and the seat heating and climate control are shut down to conserve energy.

As shown in the flowchart in FIG. 4, the engine oil is warmed up whether or not all the vehicle seats are occupied or not. In the case where none of the seats are occupied, for energy conservation purposes, the air-conditioning, interior lighting and the radio are switched off.

In the preceding description the automobile was ordered with those described technical functions. But this invention would not only shut down those functions first, but if necessary it would also know to activate or shut down other functions in the automobile.

1-7. (canceled)

8. A vehicle equipped with pressure sensors installed on or in at least one vehicle seat of the vehicle in order to determine a weight of a person sitting on the seat equipped with the pressure sensors, the seat comprising a control unit for evaluating pressure sensor signals as well as for monitoring desired functional units of the vehicle which are dependant on the pressure sensor signals, and the control unit automatically switching at least one of a transmission to neutral (N) and a parking brake to park (P) when the control unit determines that:
the vehicle is stopped,
an engine of the vehicle is running,
a key is in an ignition; and
a driver's seat of the vehicle is unoccupied by any weight.

9. The vehicle of claim 8, wherein the control unit activates a lock mechanism to lock at least one door of the vehicle.

10. The vehicle of claim 8, wherein the control unit automatically sets a position of the driver's seat according to a driver's measured weight in a given position when the engine is running and the driver's seat is occupied.

11. The vehicle of claim 8, wherein the control unit shuts off power to the at least one vehicle seat when the engine is running and the driver's seat is unoccupied.

12. The vehicle of claim 8, wherein the control unit activates at least one electrical function of respective vehicle seats when the engine is running and the control unit determines that the respective vehicle seats are occupied

13. The vehicle of claim 8, wherein the control unit interrupts electricity to at least one of an individual seat and an entire vehicle cabin when the engine is running and all the vehicle seats are unoccupied.

14. The vehicle of claim 8, wherein the control unit evaluates several pressure sensors arranged at least at seat-level of the vehicle seats and are laid out to obtain a level of pressure distribution and to determine acceleration of the vehicle and depending on the acceleration, to control at least one of a steering system, a gear shift and or a brake assembly.
